(19) United States
(12) Patent Application Publication
(10) Pub. No.: US 2012/0325855 A1
(43) Pub. Date: Dec. 27, 2012

(54) MULTI-PLATE BAR GUN AND A METHOD FOR MANUFACTURING THE SAME

(75) Inventors: Sam Brown, Bulverde, TX (US); A. A. Jud Schroeder, San Antonio, TX (US); David Santy, Converse, TX (US); Jason Minica, Schertz, TX (US)

(73) Assignee: Schroeder Industries, Inc. d/b/a Schroeder America, San Antonio, TX (US)

(21) Appl. No.: 13/543,351

(22) Filed: Jul. 6, 2012

Related U.S. Application Data
(60) Provisional application No. 61/656,784, filed on Jun. 7, 2012.

(51) Int. Cl. B67D 1/00; B32B 38/04; B32B 37/14

(52) U.S. Cl. 222/144.5; 156/257

(57) ABSTRACT

Bar guns having a body constructed from a multiplicity of color contrasting laminated acrylic sheets. The bar gun body has a nozzle, a heel, and a button assembly. Internal parts, including pistons, engage fluid channels in the bar gun body to control the flow of fluid to the bar gun nozzle.

This patent application claims the benefit and priority of, and incorporates herein by reference, U.S. Provisional Patent Application Ser. No. 61/656,784, filed Jun. 7, 2012.

### FIELD OF THE INVENTION

Bar guns constructed from a multiplicity of color contrasting laminated acrylic sheets.

### BACKGROUND OF THE INVENTION

Bar guns are used to mix and dispense a beverage from a nozzle. Bar guns are typically operated by buttons which, when pressed, will selectively connect a channel bearing a syrup concentrate and one bearing a diluent, such as soda water, for mixing and dispensing in a nozzle therefrom. Such bar guns are disclosed in U.S. Pat. No. 5,042,692 (Valiyee, et al, 1991), which discloses a bar gun handle made from acrylic; U.S. Pat. No. 7,658,006 (Schroeder, 2010, again acrylic), which is incorporated herein by reference; and US Application Publication No. 2009/0283543, showing a refrigeration system. The '006 Schroeder patent discloses a method of manufacturing a bar gun from a number of plates. Assembly includes stacking of sections in the proper order.

### SUMMARY OF THE INVENTIONS

A method for making a bar gun comprising the steps of selecting a multiplicity of cast acrylic plates with at least one of the plates being colored and contrasting in color from the others; machining the individual plates for fluid channels; assembling the plates under pressure with a solvent on the plate surfaces; machining the exterior of the assembly into a bar gun body; and adding additional parts to complete the bar gun; wherein at least some of the colored plates are translucent; wherein at least some of the colored plates are transparent, wherein at least some of the colored plates are opaque; wherein at least some of the colored plates are semi-opaque

A bar gun comprising a multiplicity of acrylic plastic plates at least one of which is colored (designated C) and at least one of which is clear (designated A); wherein the at least one colored is transparent; wherein the at least one colored transparent plate is from the group; blue, green yellow, amber, or red; and wherein the multiplicity is five and the pattern is AACAA.

A bar gun for dispensing a beverage, the bar gun comprising a multi-laminate body of acrylic plates, machined for receipt of an assemblage of parts and for fluid flow therethrough and containing the assemblage of parts adapted to control the flow of fluids therethrough, a connector for receiving and fluid coupling with the body to supply the body with a multitude of pressurized fluids; and a nozzle adapted to couple with the body and to mix a multiplicity of fluids received from the body, and to expel the mixed fluids from a mouth of the nozzle.

### BRIEF DESCRIPTION OF THE DRAWINGS

FIG. 1 is a perspective view of Applicants' laminated bar gun showing five plate layers, bottom to top.

FIGS. 1A, 1B, and 1C are the same views of FIG. 1A illustrating a bar gun visual pattern of: AACAA, ACACA, and ACCCA, as a mix of clear and colored acrylic plates.

FIGS. 2, 3, and 4 illustrate the exterior of Applicants' bar gun in front elevation, side elevation (both sides are mirrors of one another), and top elevational views.

FIG. 5 illustrates Applicants' machined individual plates 12a (five illustrated) before assembly with one of the plates being colored and the remainder being clear.

FIGS. 6A and 6B illustrate two perspective views of Applicants' machine plates after assembly and before the exterior machine shape.

FIG. 7 illustrates Applicants' machined assembled plates forming body 12c.

### DETAILED DESCRIPTION OF THE PREFERRED EMBODIMENT

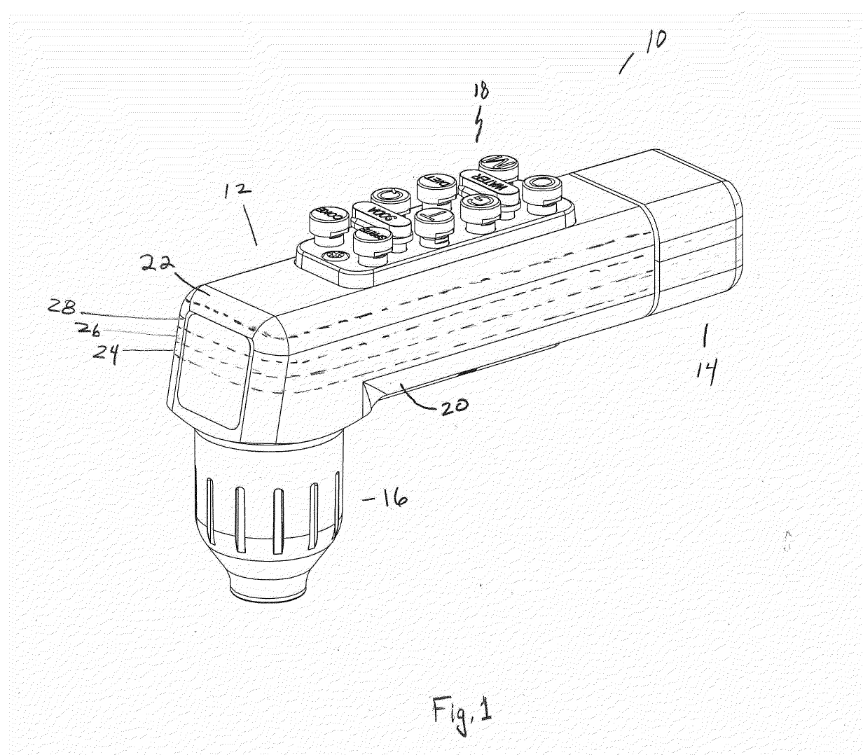

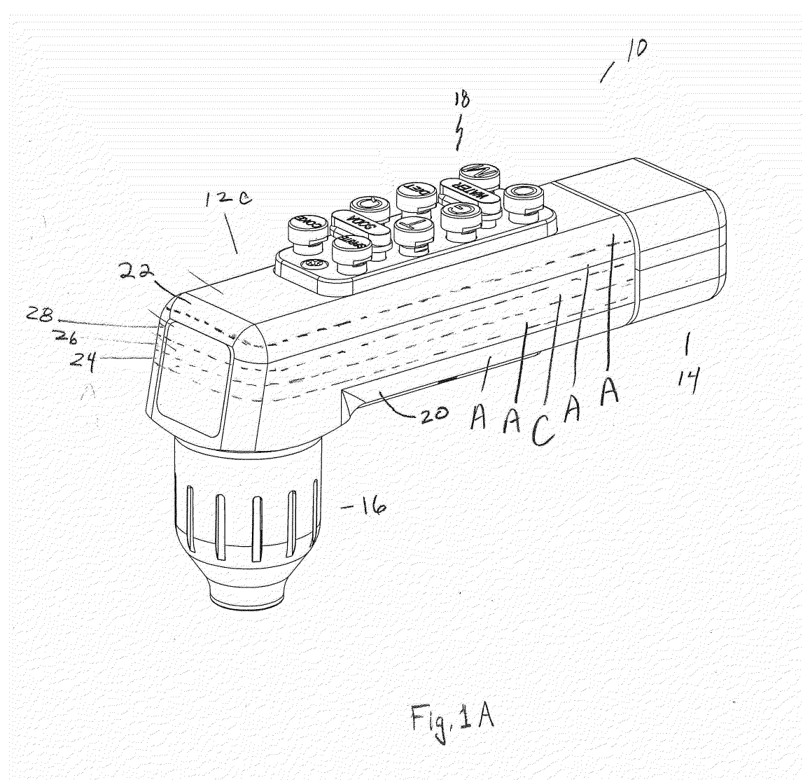

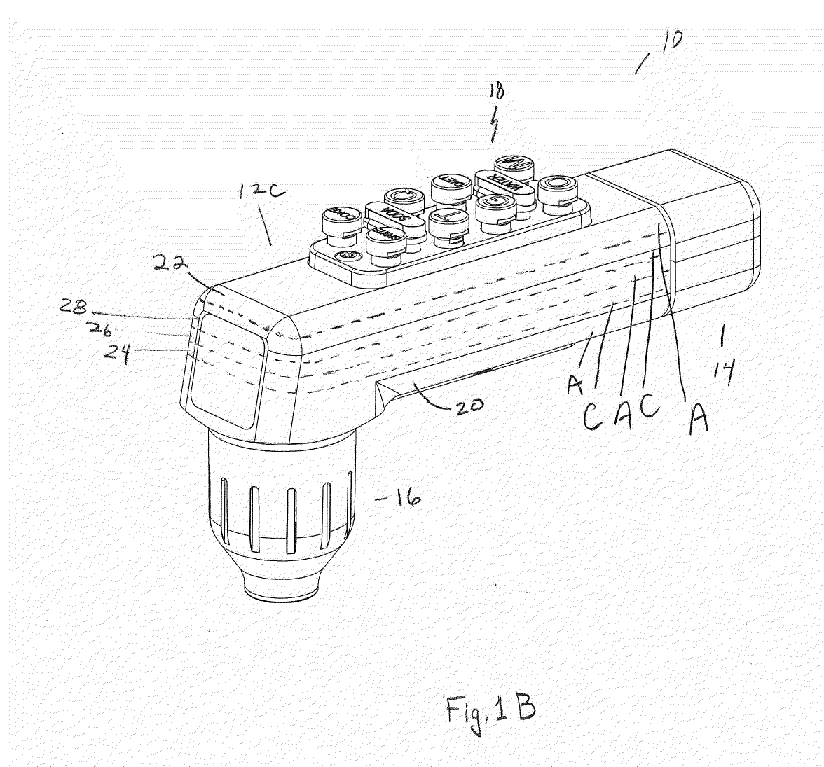

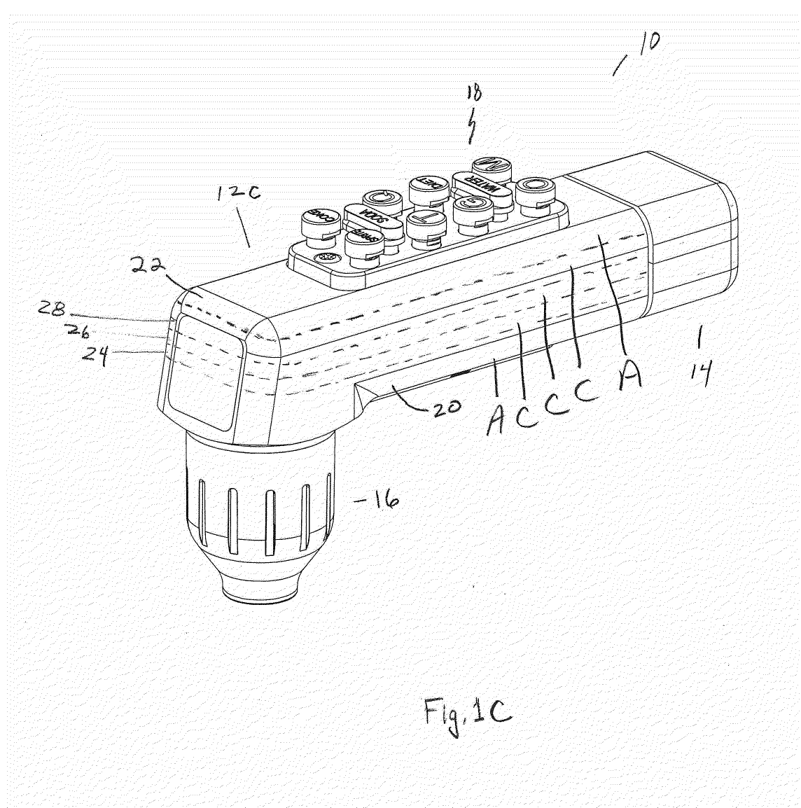

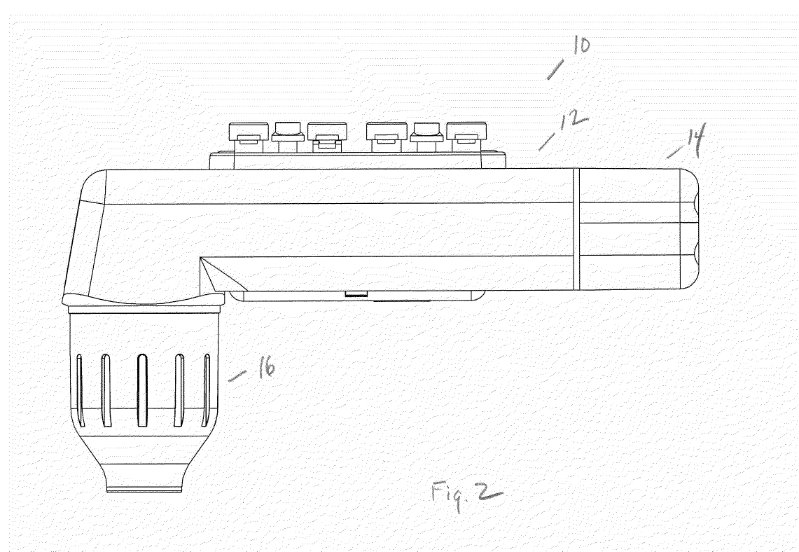

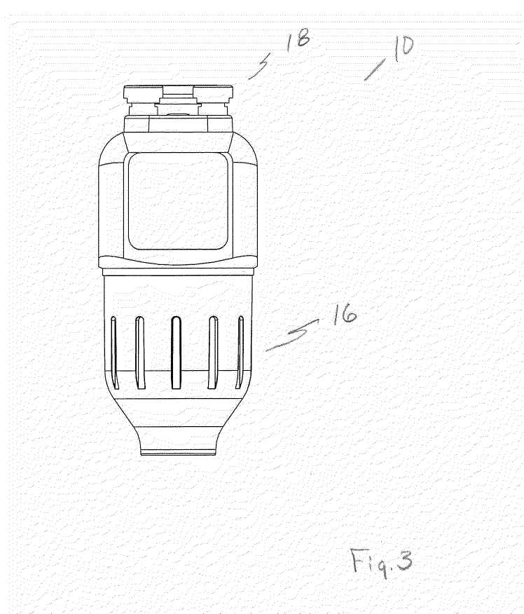

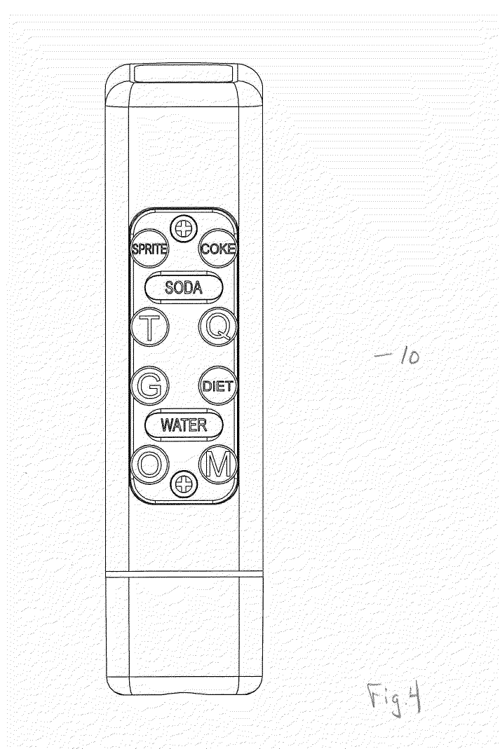

FIG. 1 illustrates a prior art bar gun 10 having a clear acrylic bar gun body 12, such as that available from Schroeder America as Part No. 6450030. One embodiment of the prior art bar gun may be found in U.S. Pat. No. 8,109,413 (Feb. 7, 2012), incorporated herein by reference.

Applicants' bar gun includes a body 12 machined in ways known in the art, the body comprising clear cast acrylic plates in multiple laminates. Bar gun body 12 has a heel 14, a nozzle 16, and button assembly 18, these elements as known in the art, engaged therewith. One assembly of internal parts (not shown) that are found inside Applicants' laminated bar gun 10 may be found in the patent publication incorporated by reference herein and include a backing plate and internal pistons, which in turn cooperate with the buttons of the button assembly to provide for the flow of fluid through the bar gun body. Still other assemblies of internal parts to control the flow of fluid through a bar gun body are known in the prior art.

As is known in the art, laminated bar guns have multiple machined clear plates. Here multiple cast acrylic plates include: a bottom plate 20, top plate 22, and intermediate plates 24/26/28. In the prior art, these plates are clear. Top and bottom plates and the intermediate plates in one embodiment total five in number. However, they may be three to seven or any suitable number.

As seen in FIGS. 1A-1C, Applicants' novel bar gun 10 may mix clear (colorless), cast acrylic plates with at least one colored (non-clear), which may be cast acrylic. The clear and colored acrylic plates may be mixed in multiple arrangements, forming multiple embodiments. The multiple plates are assembled in ways known in the art and as set forth, briefly herein, but assembly differs from the prior art in the use of at least one contrasting colored (non-clear) tabular laminate layer. Thus, the handle body comprises, typically, a colored plate mixed in with one or more clear plates. Applicants' clear laminated tabular layers are indicated with the letter A and the colored layer or layers indicated with the letter C in the attached Figures.

Incorporated herein by reference, is a current Spartech® color guide which indicates the availability of color cast acrylic sheets in standard thicknesses, such as about 0.187″. Spartech®. Stanford, Conn., www.spartech.com, Colored Acrylic Sheets, the nomenclature is as follows: Semi Opaque (Black); White Semi Opaque, Translucent, White Translucent, and Transparent in various colors.

The approximate percentage of visible light transmission is indicated under Standard ASTM tests, such as ASTM D 1003. Transparent refers to the ability to see through the colored sheet with clarity to a viewed image located behind or partly within the sheet, more particularly, to at, least some of the components, including the machined channels or interior structure. Translucent generates a diffused image, typically has less light transmission than the same color in transparent, with more scattered light than transparent, but still the ability to see some bar gun interior components or structure. Semi opaque and opaque have little to no ability to view an image on the other side of a plate and substantially no light transmission.

Applicants' designation with the letter C indicates any colored sheet, whether opaque, semi opaque, transparent or translucent, and any color. In a preferred embodiment, the semi opaque colors may be white or black, and the translucent and transparent may be any colors, at least the colors indicated on the Spartex reference. These are: red, blue, ivory, white, green yellow, and amber.

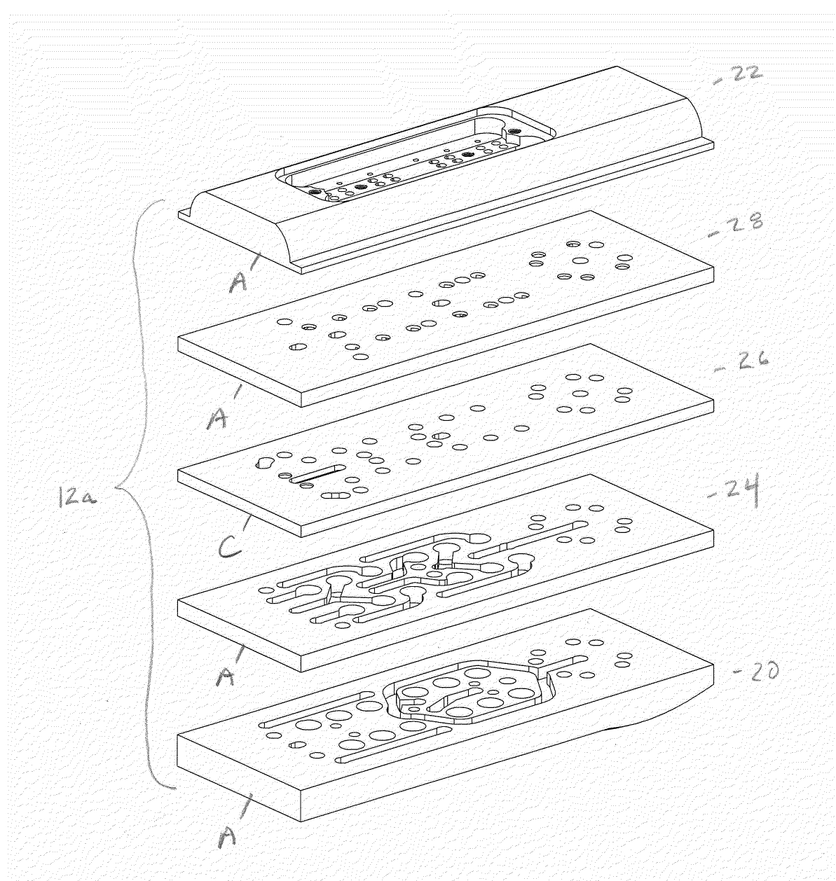

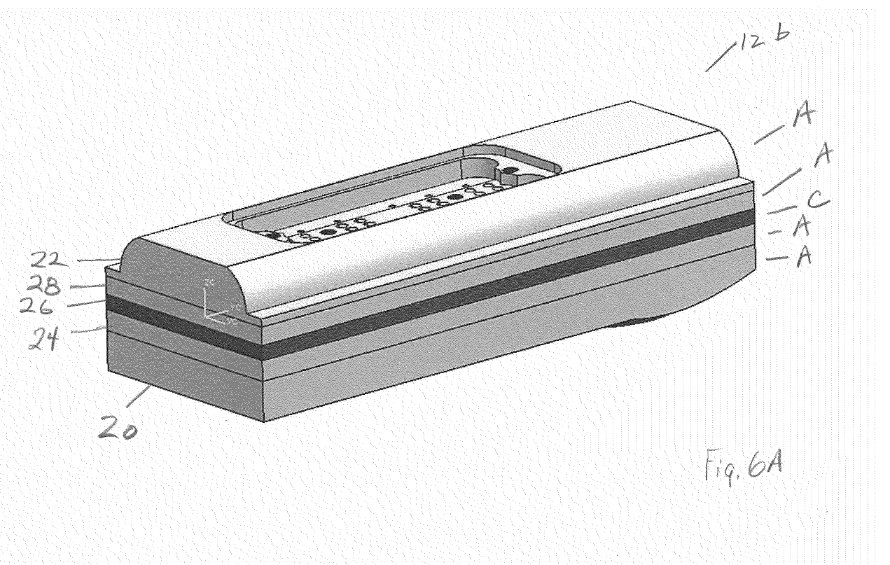

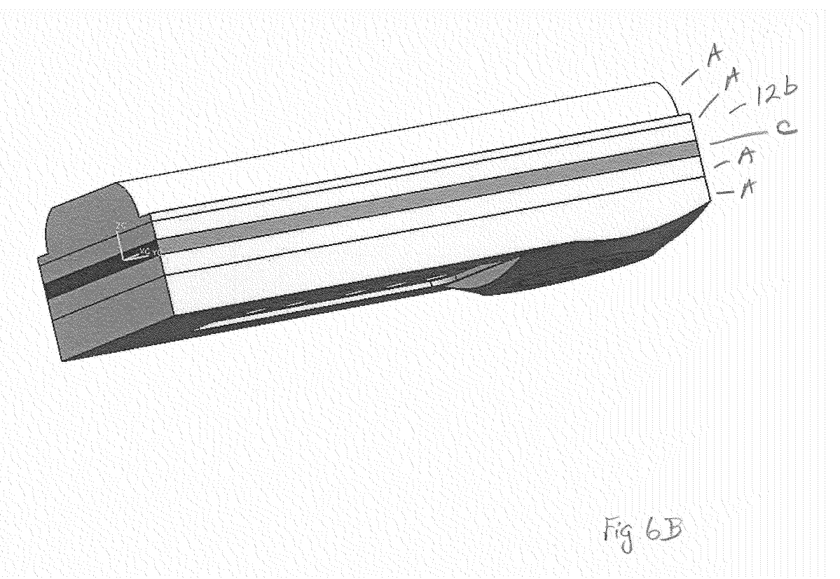

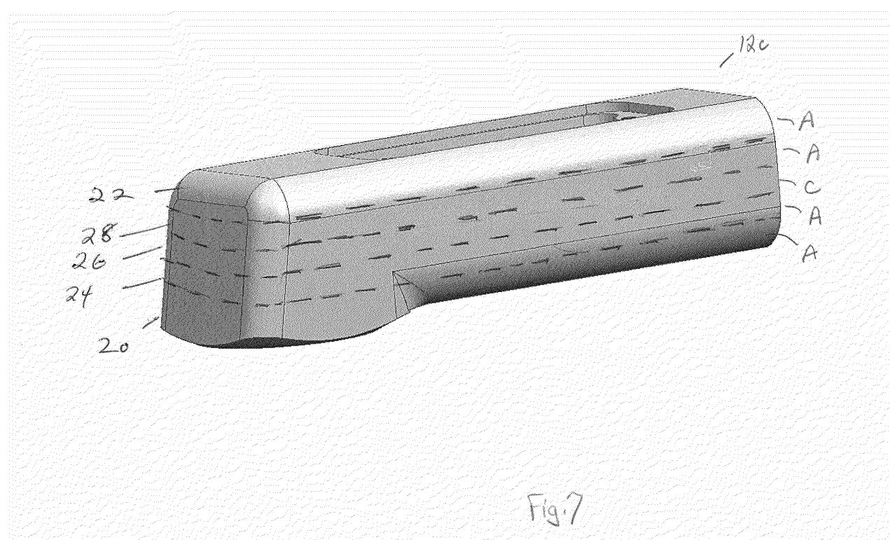

Applicant prepares a handle body from an assemblage of plates, typically choosing a combination of clear and colored or a combination of various mixed colors (no clear), and assembling them as set forth herein. Following assembly, the plates are machined in ways known in the art. FIG. 5 illustrates a five plate group of machined plates, top 22, bottom 20, and intermediate 24/26/28, after initial machining from plate stock and before gluing and compression to form the assemblies indicated in FIGS. 6A and 6B. The assembly illustrated in FIGS. 6A and 6B, illustrates the multiple plates 20/24/26/28/22 coated with a solvent and pressed in an appropriate press in ways known in the art under conditions known in the art. A second machining of the machine plate assembly 12b as seen in FIGS. 6A and 6B produces machine body 12c as indicated in FIG. 7.

FIGS. 5, 6A, 6B, and 7 show a preferred embodiment illustrated in FIG. 1A with the plate pattern AACAA, five plates 20/24/26/28/22 are illustrated. In a more specific preferred embodiment, plate 26 of the three intermediate plates designated with the letter C is any transparent or translucent red plate. One such plate is available from Spartech as Part No. 0110051, acrylic (red), about 0.187″ thick. In a second preferred embodiment, plate 26 is any transparent or translucent blue plate in a single stripe embodiment, a single plate is colored and located in any of the plate positions, remaining plates being clear or contrasting.

FIG. 1B illustrates alternate clear and colored plates and, in a preferred embodiment, these are clear and red and, in another preferred embodiment, they are clear and blue. In the multi-striped embodiment, the pattern may be ACACA or CACAC, or any alternating contrasting clear/color or color/color combination.

In FIG. 1C, an alternate preferred embodiment has three colored intermediate plates 24/26/28 with a bottom 20 and top 22 being clear. In a preferred embodiment, these colored plates are any transparent plate (of the same color) and, in a preferred embodiment, the transparent intermediate plates are either red or blue.

Other five plate combinations include: CAAAC; CCACC; CCAAA; AAACC; or CCCCC (with at least one of the plates being a different color than the others).

In one specific embodiment, an assembly of plates is provided where several are clear and at least one is red, preferably transparent red and not a top or bottom plate, to designate a change in the components of the bar guns, including the types of plungers. That is to say, Applicants' use of a specific pattern bar gun, such as, for example, AACAA (C being red), an immediate visual identification is provided to indicate to the user that the bar gun has a new assemblage of parts, including new plungers, as compared to previous bar guns that did not have the pattern or, in fact, any contrasting color. In other words, Applicants' prior art bar guns typically being AAAAA (all clear plates) may now carry, for example, in one embodiment, AACAA (C being red), an identification designating a specific type of updated bar gun, for example, containing a new or different plunger or a poppet piston.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A method for making a bar gun comprising the steps of:
selecting a multiplicity of cast acrylic plates with at least one of the plates being colored and at least one being clear;
machining the individual plates for fluid channels and receipt of fluid control ports;
assembling the plates under pressure with a solvent on the plate surfaces;
machining the exterior of the assembly into a bar gun body; and
adding additional parts to complete the bar gun.

2. The method of claim 1, wherein at least one of the selected colored plates are translucent.

3. The method of claim 1, wherein at least one of the selected colored plates are transparent.

4. The method of claim 1, wherein at least one of the selected colored plates are opaque.

5. The method of claim 1, wherein at least one of the selected colored plates are semi-opaque.

6. A bar gun comprising:
a body having multiplicity of machined acrylic plastic plates at least one of which is colored and at least one of which is clear;
a heel assembly engaging the body;
a button assembly engaging the body; and
a nozzle engaging the body.

7. The bar gun of claim 6, wherein the at least one colored plate is transparent.

8. The bar gun of claim 7, wherein the at least one colored transparent plate is from the group: white, blue, green yellow, amber, or red.

9. The bar gun is claim 7, wherein the multiplicity is five and the colored plate is red, with at least two adjacent plates being clear.

10. A bar gun for dispensing a beverage, the bar gun comprising:
a multi-laminate body of acrylic plates, machined for receipt of an assemblage of parts and for fluid flow therethrough and containing the assemblage of parts adapted to control the flow of fluids therethrough;
a connector for receiving and fluid coupling with the body to supply the body with a multitude of pressurized fluids; and
a nozzle adapted to couple with the body and to mix a multiplicity of fluids received from the body, and to expel the mixed fluids from a mouth of the nozzle.
